(19) United States
(12) Patent Application Publication
(10) Pub. No.: US 2017/0071225 A1
(43) Pub. Date: Mar. 16, 2017

(54) FOOD-GRADE TONER

(71) Applicants: Mars Incorporated, McLean, VA (US); Torrey Pines Research, Fairport, NY (US)

(72) Inventors: Lydia E. Gutierrez M., Nazareth, PA (US); Trevor Martin, Burlington (CA); Peter J. Mason, Webster, NY (US)

(21) Appl. No.: 15/343,585

(22) Filed: Nov. 4, 2016

Related U.S. Application Data
(62) Division of application No. 12/300,223, filed on Mar. 3, 2009, now abandoned.
(60) Provisional application No. 60/800,061, filed on May 12, 2006.

(51) Int. Cl. A23G 3/34; G03G 9/087; G03G 9/09; A23L 5/40; G03G 15/22

(52) U.S. Cl. CPC A23G 3/343; A23L 5/40; G03G 15/22; G03G 9/0906; G03G 9/0874; G03G 9/0902; A23V 2002/00

(57) ABSTRACT

A toner consists essentially of food-grade components. Because the toner consists essentially of food-grade components, it can be used to provide a coating or create an image on food products, including those intended for human or animal consumption.

### FIELD OF THE DISCLOSURE

This disclosure relates to food-grade toner materials that may be used, for example, to coat food and other products or mark them with an image.

### BACKGROUND

It sometimes is desirable to mark a food product with an image. Although packaging for food products may include various information, marking directly on the food product may provide additional product identification, ornamentation, advertising or marketing.

Several techniques are known for coating or marking various types of substrates. Electrostatic processes represent one group of such techniques. For example, in the reprographics industry, two primary powder-based processes are sometimes used for creating images. Such processes may use either monocomponent or dual component development systems. In the dual component system, for example, a carrier and an imaging powder, also known as a toner, are used. The carrier typically is reused in the system, whereas the toner is depleted according to the quantity of material used to create the image.

In order to apply such techniques, for example, to food products intended for human consumption, the ingredients of the toner need to satisfy particular standards that are not generally required for other applications. For example, although various materials may be used to coat or mark pharmaceutical products, such materials are not necessarily acceptable for food products.

### SUMMARY

The invention includes a toner that consists essentially of food-grade components.

Because the toner consists essentially of food-grade components, it can be used to provide a coating or create an image on food products, including those intended for human or animal consumption. Examples of such food products include confectionary items such as chocolate, candy bars, and sugar-shelled candies, including chocolate, chocolate-covered nut, or sugar confectionary candies; grain-based snack foods; and dog treats, among others.

The toner includes a thermoplastic polymer, which, in some cases, has a low glass transition temperature. The low glass transition temperature of the thermoplastic polymer allows the toner to be applied to heat-sensitive objects. For example, in some implementations, the toner may be applied to objects with a melting point of less than 120° C. Depending on the particular thermoplastic polymer, the toner may be applied to objects with even lower melting points, such as less than 65° C. For example, some heat-sensitive objects include fat- or wax-based compositions such as chocolate, which can have a melting point of about 40° C. Preferably, the surface temperature of the object is maintained below the melting point of the object as the toner is fused on the surface of the object.

By providing the toner with appropriate electrostatic features, the toner can be transferred electrostatically to the surface of an object. The toner, or a portion of the toner, may be fused on the surface of the object to create an image on the object. Unfused portions of the toner may be removed from the object.

Other features and advantages may be readily apparent from the following description, the accompanying drawings and the claims.

### DETAILED DESCRIPTION OF PREFERRED EMBODIMENTS

The toners, described in greater detail below, consist essentially of food-grade components.

By “food-grade”, in reference to a component, it is meant that the component is recognized by one skilled in the art to be acceptable for use in foods. For example, the component may be listed as a Generally Recognized as Safe direct food additive (GRAS) in section 21 of the U.S. Code of Federal Regulations, or may be EAFUS-listed (i.e., included on the U.S. Food and Drug Administration's list of “everything added to food in the United States”), or may be considered acceptable by other industry or government standards in the country or region where it is to be used. A “food-grade” toner is a toner that contains less than 100 parts per million (ppm) by weight of any impurities (i.e., less than 100 ppm by weight of any components that are not listed as GRAS, or are not EAFUS-listed, or are not considered acceptable for food use by other food-related standards).

Each toner includes a thermoplastic polymer and a colorant melt-blended together and formed into a powder. The toner also may include various additives, some of which may be added to the powdered polymer-colorant blend. The thermoplastic polymer provides a medium for containment of the colorant, for melting the toner on the surface of an object (e.g., a food product), and for exposing an image. Preferably, the thermoplastic polymer comprises at least one member from the group consisting of a copolymer of polyvinyl acetate and polyvinyipyrrolidone, a mixture of polyvinyl acetate and polyvinylpyrrolidone, polyacrylic acid cross-linked with allyl sucrose or allyl ether or pentaerythritol, poly (1-vinyl-2-pyrrolidone), poly (N-vinyl-2-pyrrolidone), gum tragacanth, a copolymer of poly-α-hydroxy carboxylic acid with a polyol, propylene glycol alginate, a fumaric acid ester, sorbitan monostearate, sorbitan tristearate, polyoxyethylene sorbitan monostearate, polyoxyethylene sorbitan tristearate, and polyoxyethylene sorbitan monooleate.

An example of a copolymer of polyvinyl acetate and polyvinylpyrrolidone is Kollidon® SR, and an example of a mixture of polyvinyl acetate and polyvinylpyrrolidone is Kollidon® VA 64, both available from BASF Corporation (Florham Park, N.J., USA).

The thermoplastic polymer preferably exhibits a glass transition temperature (Tg) in the range 50° C.≦Tg≦100° C. In some cases, it may be desirable to use a thermoplastic polymer having a glass transition temperature (Tg) equal to or less than 65° C. Thermoplastic polymers with low glass transition temperatures may be desirable to avoid melting the food product during the fusing process. For example, some heat-sensitive objects include fat- or wax-based compositions such as chocolate, which can have a melting point of about 40° C.

A colorant, such as a pigment or dye, may be included in the toner to provide a desired color. Either natural or synthetic pigments and dyes may be used. Examples of synthetic colorants include FD&C Blue #1, FD&C Blue #2, FD&C Green #3, FD&C Red #3, FD&C Red #40, FD&C Yellow #5, FD&C Yellow #6, titanium dioxide (anatase crystal form), calcium carbonate and ferrous gluconate. Examples of natural colorants include caramel, cochineal, carmine, annatto, β-carotene, saffron, turmeric, indigo, monascus, iridoids, chlorophyll, anthocyanins, betalains and vegetable black.

In addition to the thermoplastic polymer and colorant, the toner optionally may include one or more of a charge control additive, a wax additive, a plasticizer, a filler or diluent, or a surface additive.

A charge control additive, which may be added to the powdered polymer-colorant blend, may enhance the magnitude and rate of triboelectric charging and can help ensure stable electrostatic charging over an extended time. Examples of charge control additives include the following: quaternary ammonium salts, benzalkonium chloride, benzethonium chloride, cetrimide (trimethyl tetradecyl ammonium bromide), cyclodextrins (and adducts), silicon dioxide, aluminum oxide, titanium dioxide and carbon black. The toner preferably has a triboelectric charge to mass ratio (Q/M) in the range 5≦Q/M≦35 microcoulombs per gram (μC/g), when frictionally charged against a suitable surface. The charge control additive may be added to the bulk of the toner composition or applied to the surface of the toner composition.

A wax additive may help improve the fusing behavior of the toner and dispersion characteristics of components in the toner. Examples of such materials include block copolymers of ethylene oxide and propylene oxide available as poloxamers (e.g., Lutrol® and Pluronic® F Grade available from BASF Corporation located in Florham Park, N.J., U.S.A.), hydrogenated castor oil, cetyl stearyl alcohol, cetyl esters, carnauba wax, microcrystalline wax, white wax (i.e., chemically bleached beeswax), xanthan gum, and lecithin. The wax additive preferably has a melting point in the range of 80-120° C.

A plasticizer may significantly lower the glass transition temperature (Tg) of the thermoplastic polymer, making it more pliable and easier to work with. Examples of plasticizers include esters of higher fatty acids, glycerides, glycol esters of coconut oil fatty acids, dibutyl sebacate, triethyl citrate, triacetin, and acetylated monoglycerides.

Adding a filler or diluent to the composition of the toner can enable reduction of the overall cost and may enhance capacity. It also can be used as a deglossing agent or to influence powder flow properties. Examples of fillers and diluents include alginic acid, bentonite, calcium carbonate, kaolin, talc, magnesium aluminum silicate and magnesium carbonate.

The toner may include a surface additive, for example, to enhance and/or control its powder flow properties and triboelectric charging properties. Examples of surface additives include: hydrophilic fumed silica, fumed titanium dioxide, zinc oxide, alumina, zinc stearate, magnesium stearate and calcium stearate.

The amounts of the various components in the toner may vary depending upon the application. However, ranges (in % by weight) that may be suitable for some applications are as follows: thermoplastic polymer (50-98% by wt), colorant (1-40% by wt), wax additive (0-30% by wt), charge control additive (0-20 by % wt), filler or diluent (0-50% by wt), surface additive (0-10% by wt) and plasticizer (0-20% by wt). For some applications, the following narrower ranges (in % by weight) may be appropriate: thermoplastic polymer (70-96% by wt), colorant (2-30% by wt), wax additive (0-20% by wt), charge control additive (0-10% by wt), filler or diluent (0-20% by wt), and surface additive (0-5% by wt). Even narrower ranges (in % by weight) may be suitable for some applications: thermoplastic polymer (80-95% by wt), colorant (5-20% by wt), wax additive (0-5% by wt), charge control additive (0-5% by wt), filler or diluent (0-15% by wt), and surface additive (0-2.5% by wt).

One technique for preparing the toner includes premixing the toner ingredients other than the surface additives. The mixed toner ingredients are melt-blended at a temperature high enough to ensure good dispersion and distribution of all components in the toner polymer binder. The viscoelastic melt-blend then is cooled to ambient temperature or below to achieve a brittle compound that can be pulverized to a reduced particle size. Optionally, the process may include mechanically pre-grinding the cooled compounded material to a particle size suitable for micronization or pulverization. A micronization or pulverization process is performed to reduce the material to a pre-specified particle size average. Next, the micronized or pulverized particles are classified to produce a predefined particle size distribution. A surface additive, or combination of surface additives, optionally may be blended onto the surface of the classified toner.

Preferably, at least 95% of the particles in the toner have a diameter of less than about 30 microns. In some cases, it may be desirable that at least 95% of the particles in the toner have a diameter of less than about 20 microns or, in other cases, less than about 10 microns. For other applications, different size particles may be appropriate. However, it is preferable that the size of the particles should be greater than about 1 micron.

In the following paragraphs, a number of specific examples are disclosed.

### Example 1

A blue food-grade toner was prepared by the following procedure.

The following ingredients were added to a Henschel Blender Model SF10 and mixed for 2 minutes at 3500 rpm:

| | |
|---|---|
| FD&C Blue Lake #1 | 500 grams |
| Kollidon ® SR Poly (vinyl acetate-vinyl pyrrolidinone) | 4500 grams |
| Total | 5000 grams |

The mixed material was fed to a Buss Model TCS 30 single screw reciprocating extruder with screw length to diameter ratio (L/D)=18.

The extruder was operated at a temperature of 120° C. at a rotational speed of 200 rpm and a feed rate of 5 lbs/hour.

The resulting melt-blend was cooled and flattened on a chill roller and then mechanically ground to a particle size of ˜1 min in a hammer mill. The resultant material was used as the feed for Alpine jet mill model No. 100AFG with a feed rate of 5 lbs/hour.

Classification of the particles to remove undesirable oversize or undersize particles was performed using a Labo Elbow Jet Classifier with 3 kg of toner particles with a particle size of ˜10 microns being collected. The particle size analysis of the resultant particles indicated a mean particle diameter of 9.6 μm with a geometric standard deviation from the mean equal to 1.35.

The triboelectric charge (Q/M) of this toner was measured by first roll-milling the toner with a ferrite carrier at a toner concentration of 9.25% by wt for 30 minutes. The sample was then placed on the lower plate of a rotary parallel plate fixture. The plates were rotated while a magnetic field was applied to the lower plate and an electric field between the plates. The toner moved to the upper plate and the resulting current was measured. The toner mass was also measured. The calculated Q/M from these measurements was 23.4 μCoulomb/gram.

### Example 2

A different blue food-grade toner was prepared by the following procedure.

The following ingredients were added to a Henschel Blender Model SF10 and mixed for 1.75 minutes at 3000 rpm:

| | |
|---|---|
| FD&C Blue Lake #1 | 500 grams |
| Kollidon ® SR Poly (vinyl acetate-vinyl pyrrolidinone) | 4250 grams |
| Lutrol ® F68 Poly (ethylene oxide/propylene oxide) wax | 250 grams |
| Total | 5000 grams |

The mixture was melt-blended in a Buss extruder, as in Example 1, except that the extruder temperature was set at 115° C. and the feed rate was 4 lbs/hour.

The resultant melt-blend was micronized and classified under the same conditions as Example 1 to yield 3000 grams of blue toner. The mean particle size was determined to be 9.9 μm with a geometric standard deviation from the mean equal to 1.34.

The triboelectric charge (Q/M) of this toner was measured by first roll-milling the toner with a ferrite carrier at a toner concentration of 8.5% by wt for 30 minutes. The sample was then placed on the lower plate of a rotary parallel plate fixture. The plates were rotated while a magnetic field was applied to the lower plate and an electric field between the plates. The toner moved to the upper plate and the resulting current was measured. The toner mass was also measured. The calculated Q/M from these measurements was 24 μCoulomb/gram.

### Example 3

A white food-grade toner was prepared according to the procedure described in Example 1, with the exception that the following materials formulation was employed:

| | |
|---|---|
| Anatase food-grade titanium dioxide | 800 grams |
| Kollidon ® SR Poly (vinyl acetate-vinyl pyrrolidinone) | 3200 grams |
| Total | 4000 grams |

After melt-blending, micronization and classification, there was obtained 2500 grams of white toner. The mean particle size was determined to be 10.24 μm with a geometric standard deviation of 1.36.

The triboelectric charge (Q/M) of this toner was measured by first roll-milling the toner with a ferrite carrier at a toner concentration of 9.6% by wt for 30 minutes. The sample was then placed on the lower plate of a rotary parallel plate fixture. The plates were rotated while a magnetic field was applied to the lower plate and an electric field between the plates. The toner moved to the upper plate and the resulting current was measured. The toner mass was also measured. The calculated Q/M from these measurements was 25.8 μCoulomb/gram.

### Example 4

A second white food-grade toner was prepared according to the procedure described in Example 3, with the exception that the following materials formulation was employed:

| | |
|---|---|
| Anatase food-grade titanium dioxide | 500 grams |
| Kollidon ® SR Poly (vinyl acetate-vinyl pyrrolidinone) | 4375 grams |
| Lutrol ® F68 Poly (ethylene oxide/propylene oxide) wax | 125 grams |
| Total | 5000 grams |

Melt-blending was carried out in the same manner as in Example 3, but the feed rate to the Alpine jet-mill was reduced to 2 lbs/hour. After melt-blending, micronization and classification, there was obtained 3500 grams of white toner. The mean particle size was determined to be 9.63 μm with a geometric standard deviation of 1.37.

The triboelectric charge (Q/M) of this toner was measured by first roll-milling the toner with a ferrite carrier at a toner concentration of 9.8% by wt for 30 minutes. The sample was then placed on the lower plate of a rotary parallel plate fixture. The plates were rotated while a magnetic field was applied to the lower plate and an electric field between the plates. The toner moved to the upper plate and the resulting current was measured. The toner mass was also measured. The calculated Q/M from these measurements was 29.1 μCoulomb gram.

### Example 5

A black food-grade toner was prepared according to the procedure described in Example 1, with the exception that the following materials formulation was employed:

| | |
|---|---|
| FD&C Blue Lake #1 | 250 grams |
| FD&C Red Lake #40 | 250 grams |
| FD&C Yellow Lake #5 | 250 grams |
| Kollidon ® SR Poly(vinyl acetate-vinyl pyrrolidinone) | 4250 grams |
| Total | 5000 grams |

Melt-blending was carried out in the same manner as in Example 1, except that the feed rate to the Alpine jet-mill was reduced to 2 lbs/hour. After melt-blending, micronization and classification, there was obtained 3800 grams of black toner. The mean particle size was determined to be 10.7 μm with a geometric standard deviation of 1.45.

The triboelectric charge (Q/M) of this toner was measured by first roll-milling the toner with a ferrite carrier at a toner concentration of 13.9% by wt for 30 minutes. The sample was then placed on the lower plate of a rotary parallel plate fixture. The plates were rotated while a magnetic field was applied to the lower plate and an electric field between the plates. The toner moved to the upper plate and the resulting current was measured. The toner mass was also measured. The calculated Q/M from these measurements was 15.4 μCoulomb/gram.

In other implementations, processes different from the particular examples described above can be used to produce the toner.

In some implementations, a chemical process is employed to manufacture the toner. Microencapsulation or other chemical processes to prepare toner-sized particles can obviate the requirement for a pulverization step to reduce particle size, because particle size and size distribution can be targeted and controlled during the chemical steps. For example, spray drying or a coacervation process can be used for the preparation of toner-sized microcapsules and allow the use of commercially available approved food additives (e.g., polymers, plasticizers, particle stabilizers, and food colorants).

The micro-encapsulation process provides the ability to separate the functions of the shell and the core. The shell should have mechanical strength so that the toner can survive intact during the charging and development process; thermal stability and ability to meet the desired non-blocking properties; and triboelectric charging properties and powder flow properties, by using appropriate surface additives embedded in the shell. The core may provide the fusing and fixing properties and color characteristics, by constraint of the colorant within the core material. For example, a high Tg shell material can be used in conjunction with a low Tg core composition. Upon heating during the fusing process, the expanding core material will rupture the shell, and permit fixing of the total toner composition to the candy surface.

In some implementations, esters of sorbitol such as sorbitan monostearate and sorbitan tristearate can be used as major components of the core composition. Additionally, polysorbates such as polyoxyethylene sorbitan monostearate (Polysorbate 60), polyoxyethylene sorbitan tristearate (Polysorbate 65), and polyoxyethylene sorbitan monooleate (Polysorbate 80) can be used.

The copolymer of polyvinyl acetate and polyvinyl pyrrolidone (e.g., Kollidon® VA 64) also can be used as a core polymer because it is protected from the environment by the surrounding shell and problems with water absorption may be alleviated.

For the shell composition, preferably a tough, water-impermeable, high Tg polymer is used to meet the desired shell requirements.

The food-grade toners can be used to provide a coating or create an image, for example, on three-dimensional objects, including food products intended for human consumption.

For example, the toner may be transferred electrostatically to the surface of the object. The toner, or a portion of the toner, then may be fused on the surface of the object to create the image. Unfused portions of the toner subsequently may be removed from the object.

A particular technique for creating an image on the surface of a sugar-shelled candy is described below. The technique also can be used to create an image on the surface of other objects.

An initial stage in the technique includes coating the candy with the toner. According to a particular implementation, the toner is combined mechanically with a magnetically active powder (i.e., a carrier) to produce a developer. The carrier serves to charge the toner triboelectrically and to transport the toner to the image-bearing surface of the candy by electrostatic forces. Preferably, the carrier also consists essentially of food contact-grade components. The toner and carrier should be blended so as to optimize the electrostatic and other properties for the particular toner application and imaging system. Alternatively, a corona or other charging technique may be used

The candy preferably is held such that an electric field is established between the candy surface to be coated and the development system. That can be achieved, for example, by biasing the developer with a voltage of a first polarity, and biasing the candy with a voltage of an opposite polarity. The holder for the candy should be isolated electrically from the candy so that it does not become coated with toner.

In some cases, parts of the surface of the candy may be coated selectively with the toner. For example, it may be preferable to coat only one side of the candy. In some cases, a screen with one or more openings may be placed near the candy or other object so that the screen selectively blocks the toner from being applied to portions of the object.

If the electric field between the toner and the candy is stronger than the electrostatic forces holding the toner to the surface of the magnetic carrier powder, some of the toner will be attracted to the surface of the candy where it is held electrostatically. Thus, the candy, or a portion of the candy, can be coated with the toner in a non-contact manner. The amount of toner on the candy may be controlled by the size of the electric field, the relative speed of the candy passing by the area where the toner is held, the duration of the applied field, and the electrostatic charge on the toner, and the toner concentration (the amount of toner relative to the amount of carrier). Once the candy is coated with the toner, the toner is held electrostatically and should not fall off. The candy can be processed without any additional requirement to tack or secure the toner on the surface.

Next, the specified image is created on the surface of the candy. The candy may be subjected to a source of energy to obtain localized fusing of the toner on the candy surface according to the desired image. This may be accomplished, for example, by a laser thermal imaging technique in which light from a laser melts the toner so that the toner particles fuse together and adhere to desired areas on the surface of the candy. Preferably, the surface temperature of the object is maintained below a melting point of the object even during the fusing process. As noted above, the thermoplastic polymer may have a relatively low glass transition temperature, which allows the toner to be applied to, and fused on, heat-sensitive objects without damaging the objects. The unfused toner remaining on the surface is undisturbed. In some cases, after the imaging step has been completed, there may be no readily visible appearance change in the toner on the surface of the candy.

Next, the unfused toner is removed from the surface of the candy, thus leaving the desired fused image on the surface. The unfused portions of the toner may be removed from the candy by a non-contact technique using electrostatic forces.

Details of a specific system for implementing the foregoing technique are described in a PCT Patent Application filed on May 10, 2007 and entitled “USE OF POWDERS FOR CREATING IMAGES ON OBJECTS, WEBS OR SHEETS” (Attorney Docket No. 21157-004WO1). The disclosure of that application is incorporated herein by reference.

The images formed on the surface of candy may include one or more alphanumeric symbols, graphic symbols, or other types of images. The image created by the toner may be monochromatic or multichromatic. In the case of a multichromatic image, the process for applying and fusing the toner to the object may be repeated using two or more food-grade toners having different colors. In addition to other colors, the colorant included in the toner may result in the toner appearing white. Such a white colored toner may be used, for example, to mask an underlying candy color for subsequent process color imaging.

In some cases, a first toner may be applied and fused over part or over the entire surface of the object and can serve as a coating. A second toner having a different color then may be applied and fused on the surface of the object to form image.

In some implementations, a white coating is applied to the substrate surface followed by an image in a transparent or opaque color. In other implementations, an opaque color image alone is applied directly to the substrate surface. Thus, an image can be printed on a non-white surface.

In some implementations, the toner is prepared to can a, flavor, and/or texture-providing components.

The food-grade toners may be used in connection with confectionary items such as chocolate, candy bars, and sugar-shelled candies, including chocolate, chocolate-covered nut, and sugar confectionary candies; grain-based snack foods; dog treats; and other food products intended for human or animal consumption. They also may be applied to non-food items. The toners may be applied to objects having curved or irregular surfaces as well as flat surfaces.

Other implementations are within the scope of the claims.

1.-13. (canceled)

14. A method of creating an image on an object, the method comprising:
electrostatically transferring a toner to a surface of the object, and
fusing at least a portion of the toner on the surface of the object,
wherein the toner consists essentially of food-grade components and comprises a thermoplastic polymer, a colorant and a triboelectric charge control additive, and wherein the thermoplastic polymer comprises at least one member from 10 a group consisting of:
a copolymer of polyvinyl acetate and polyvinylpyrrolidone,
a mixture of polyvinyl acetate and polyvinylpyrrolidone,
polyacrylic acid cross-linked with allyl sucrose or allyl ether or pentaerythritol, poly (1-vinyl-2-pyrrolidone),
poly (N-vinyl-2-pyrrolidone),
gum tragacanth,
a copolymer of poly-a-hydroxy carboxylic acid with a polyol, propylene glycol alginate,
a fumaric acid ester,
sorbitan monostearate,
sorbitan tristearate,
polyoxyethylene sorbitan monostearate,
polyoxyethylene sorbitan tristearate, and
polyoxyethylene sorbitan monooleate.

15. The method of claim 14 including selectively coating parts of the surface of the object with the toner.

16. The method of claim 14 including biasing a toner development system used to transfer toner to the object with a voltage of a first polarity, and biasing the object with a voltage of an opposite polarity.

17. The method of claim 14 including subjecting the object to a source of energy to obtain localized fusing of the toner on the object wherein, during the fusing, a surface temperature of the object is maintained below a melting point of the object.

18. The method of claim 14 including removing unfused portions of the toner: from the object.

19. The method of claim 18 wherein unfused portions of the toner are removed from the object by a non-contact technique using electrostatic forces.

20. The method of claim 14 wherein the toner forms an image on the surface of the object, and wherein the image includes at least one alphanumeric or graphic symbol.

21. The method of claim 14 wherein the object is a sugar-shelled candy.

22. The method of claim 14 wherein the method comprises:
performing said electrostatic transfer and said fusing with toners of at least two different colors,
wherein each of the toners consists essentially of food-grade components and comprises a thermoplastic polymer, a colorant and a triboelectric charge control additive, and wherein the thermoplastic polymer comprises at least one member from a group consisting of:
a copolymer of polyvinyl acetate and polyvinylpyrrolidone,
a mixture of polyvinyl acetate and polyvinylpyrrolidone,
polyacrylic acid cross-linked with allyl sucrose or allyl ether or pentaerythritol,
poly (1-vinyl-2-pyrrolidone),
poly (N-vinyl-2-pyrrolidone),
gum tragacanth,
a copolymer of poly-a-hydroxy carboxylic acid with a polyol, propylene glycol alginate,
a fumaric acid ester,
sorbitan monostearate,
sorbitan tristearate,
polyoxyethylene sorbitan monostearate,
polyoxyethylene sorbitan tristearate, and
polyoxyethylene sorbitan monooleate.
